(19) United States
(12) Patent Application Publication
(10) Pub. No.: US 2009/0149098 A1
(43) Pub. Date: Jun. 11, 2009

(54) Instrument panel for a motor vehicle

(76) Inventors: Odysseus Andronis, Wolfenbuettel (DE); Gustav Hofmann, Braunschweig (DE); Niels Kleindienst, Berlin (DE)

Correspondence Address: KENYON & KENYON LLP, ONE BROADWAY, NEW YORK, NY, 10004, US

(21) Appl. No.: 11/664,856

(22) PCT Filed: Aug. 30, 2005
(86) PCT No.: PCT/EP05/09304

§ 371 Date: Dec. 10, 2008

(30) Foreign Application Priority Data
Oct. 5, 2004 (DE) 10 2004 048 331.0

(51) Int. Cl. D03D 15/00; D03D 25/00

(52) U.S. Cl. 442/181; 296/208; 296/70

(57) ABSTRACT

An instrument panel or an interior trim panel for a motor vehicle or vehicle includes a support and a woven cover positioned over the support, the woven cover including warp threads and weft threads, as well as crossing points of the warp threads and weft threads, and the density of the crossing points being substantially independent of the surface geometry of the support.

### FIELD OF THE INVENTION

The present invention relates to an instrument panel for a motor vehicle and/or vehicle. The present invention also relates to an interior trim panel for a motor vehicle and/or vehicle.

### SUMMARY

Example embodiments of the present invention may provide an improved instrument panel for a motor vehicle and/or vehicle and an improved interior trim panel for a motor vehicle and/or vehicle.

According to example embodiments of the present invention, an instrument panel and/or an interior trim panel for a motor vehicle and/or vehicle includes a support and a woven cover situated over the support, the woven cover including warp threads and weft threads, as well as crossing points of the warp threads and weft threads, and the density of the crossing points being substantially independent of the surface geometry of the support. Such a woven cover may be woven to have a density of crossing points of warp threads and weft threads, which is a function of the surface geometry of the support. A weaving method particularly suitable for weaving an above-mentioned, woven cover is described in European Published Patent Application No. 0 819 188 and PCT International Published Patent Application No. WO 96/3164. In this context, the woven cover is woven to span a three-dimensional contour, which substantially corresponds to the surface geometry of the carrier in the region on which the woven cover is situated. This allows the density of the crossing points to be substantially independent of the surface geometry of the support, when the woven cover is situated on the support.

In this context, it may be provided that the support have a region having a flat surface on which a part of the woven cover is situated, and a region having a convex surface on which a part of the woven cover is situated. The density of the crossing points of the woven cover above the region of the support having the flat surface is substantially equal to the density of the crossing points of the woven cover above the region of the support having the convex surface. If the support has a region having a concave surface on which a part of the woven cover is situated, it may be provided that the density of the crossing points of the woven cover above the region of the support having the flat surface is substantially equal to the density of the crossing points of the woven cover above the region of the support having the concave surface.

A nanocoating may be situated on a surface of the woven cover facing away from the support. Suitable nanocoatings may be found, for example, on the following Internet pages:
deutsche.nature.com/nsu/stories/040607-9.html
www.trendforum.de/textil.htm
www.etc-products.de/Produkte/Textil/textil.htm

The nanocoating TCN-7050 described on the Internet page www.etc-products.de/Produkte/Textil/textil.htm may be a transparent, inorganic-organic composite matrix having hydrophobic terminal groups.

At least one air duct may be situated in the support. In this context, the air duct may include at least one air outlet covered by the woven cover.

At least one warp thread and/or at least one weft thread may include metal, carbon, a piezoelectric material, and/or an electroluminescent material. At least one warp thread and/or at least one weft thread may include a metallic filament, a carbon filament, a pressure-measuring filament, a heating filament, a temperature-measuring filament, a piezoelectric filament, and/or an electroluminescent light filament.

According to example embodiments of the present invention, a motor vehicle and/or vehicle includes an instrument panel, e.g., one including one or more of the above-mentioned features, and/or an interior trim panel, e.g., one including one or more of the above-mentioned features. The instrument panel and/or the interior trim panel include a support and a woven cover situated over the support. The woven cover includes warp threads and weft threads, as well as crossing points of the warp threads and weft threads. The density of the crossing points is substantially independent of the surface geometry of the support.

The motor vehicle and/or vehicle may include a windshield, the woven cover having a region in which the degree of light absorption of the woven cover increases with decreasing distance to the windshield.

According to example embodiments of the present invention, in a method for manufacturing an instrument panel, e.g., one including one or more of the above-mentioned features, and/or for manufacturing an interior trim panel, e.g., one including one or more of the above-mentioned features: a support having the geometry of the instrument panel and/or the interior trim panel is formed; a cover is woven, which has a density of crossing points of the warp threads and weft threads that is a function of the surface geometry of the support; and the support is covered by the cover.

The woven cover may be woven to span a three-dimensional contour, which substantially corresponds to the surface geometry of the carrier in the region on which the woven cover is situated.

A motor vehicle may be, e.g., a land vehicle that may be used individually in road traffic. Motor vehicles are specifically not limited to land vehicles having an internal combustion engine.

Further features and aspects of exemplary embodiments of the present invention are described in more detail below with reference to the appended Figures.

### BRIEF DESCRIPTION OF THE DRAWINGS

FIG. 1 illustrates an exemplary embodiment of an instrument panel.

FIG. 2 is a cross-sectional view of the instrument panel illustrated in FIG. 1.

FIG. 3 is a schematic view of a cut-out of a woven cover.

FIG. 4 is a cross-sectional view of an exemplary embodiment of an operating element.

FIG. 5 is a cross-sectional view of an exemplary embodiment of a further operating element.

FIG. 6 is a cross-sectional view of an exemplary embodiment of a further operating element.

FIG. 7 illustrates an exemplary embodiment of a further operating element.

FIG. 8 is a schematic view of an exemplary embodiment of a woven cover.

FIG. 9 is a cross-sectional view of an exemplary embodiment of a light filament.

FIG. 10 is a cross-sectional view of a further exemplary embodiment of a light filament.

FIG. 11 is a schematic view of an exemplary embodiment of a vehicle.

FIG. 12 is a cross-sectional view of an exemplary embodiment of a motor-vehicle door.

### DETAILED DESCRIPTION

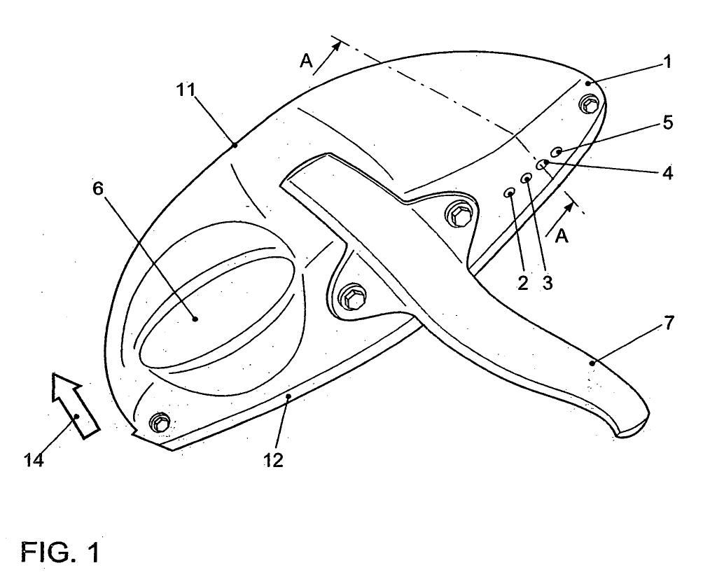

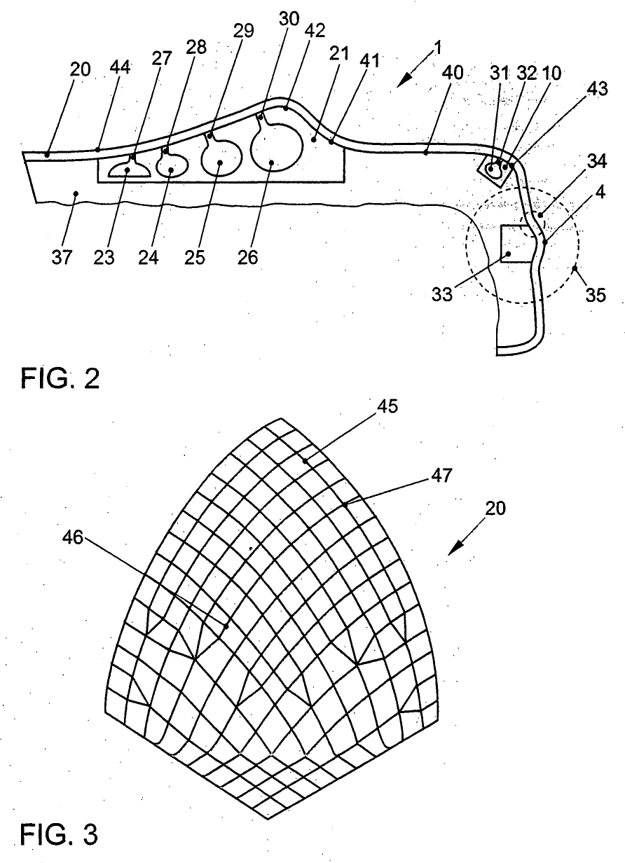

FIG. 1 shows an exemplary embodiment of an instrument panel 1, and FIG. 2 shows a cross-section of instrument panel 1 illustrated in FIG. 1 taken along line A-A. Reference numeral 7 denotes a part of a center console. Instrument panel 1 has an instrument cluster 6. Instrument panel 1 additionally includes a support 37 and a cover 20 situated over or on support 37. A nanocoating is situated on a surface 44 of woven cover 20 facing away from support 37. Suitable nanocoatings may be found, for example, on the following Internet pages:
deutsche.nature.com/nsu/stories/040607-9.html
www.trendforum.de/textil.htm
www.etc-products.de/Produkte/Textil/textil.htm

Foam members 10 and 21 having air ducts 31 and 23, 24, 25, 26, respectively, are embedded in support 37. Air ducts 31, 23, 24, 25, 26 may also be directly situated in support 37. Air ducts 31, 23, 24, 25, 26 include air outlets 32, 27, 28, 29, covered by woven cover 20.

As exemplarily shown in FIG. 3 as a basic representation for the detail denoted by dashed circle 34 in FIG. 2, woven cover 20 includes warp threads 45 and weft threads 46, as well as crossing points 47 of warp threads 45 and weft threads 46, the density of crossing points 47 being substantially independent of the surface geometry of support 37. To this end, woven cover 20 having a density of crossing points 47 of warp threads 45 and weft threads 46, which is a function of the surface geometry of support 37, is woven with the aid of a weaving method described, e.g., in European Published Patent Application No. 0 819 188 and PCT International Published Patent Application No. WO 96/3164. In this context, woven cover 20 is woven to span a three-dimensional contour, which substantially corresponds to the surface geometry of carrier 37 in the region on which woven cover 20 is situated. This allows the density of crossing points 47 to be substantially independent of the surface geometry of support 37, when woven cover 20 is situated on support 37.

The density of crossing points 47, which is substantially independent of the surface geometry of support 37, allows the density of crossing points of woven cover 20 above a region 40 of support 37 having a flat surface to be substantially equal to the density of the crossing points of woven cover 20 above a region 42, 43 of support 37 having a convex surface, as well as equal to the density of the crossing points of woven cover 20 above a region 41 of support 37 having a concave surface.

Reference numeral 11 in FIG. 1 denotes a side of instrument panel 1 facing a windshield. Reference numeral 12 in FIG. 1 denotes a side of instrument panel 1 facing away from a windshield and facing a passenger compartment. In an example embodiment of instrument panel 1, woven cover has a degree of light absorption, which is indicated by the arrow designated by reference numeral 14 and increases with decreasing distance to the windshield.

Instrument panel 1 additionally includes operating elements 2, 3, 4, 5, whose arrangement is explained using operating element 4 as an example. Operating element 4 includes a pressure-measuring element 33, which is embedded in support 37 and covered by woven cover 20 and converts a pressure applied to woven cover 20 over pressure-measuring element 33 into a voltage.

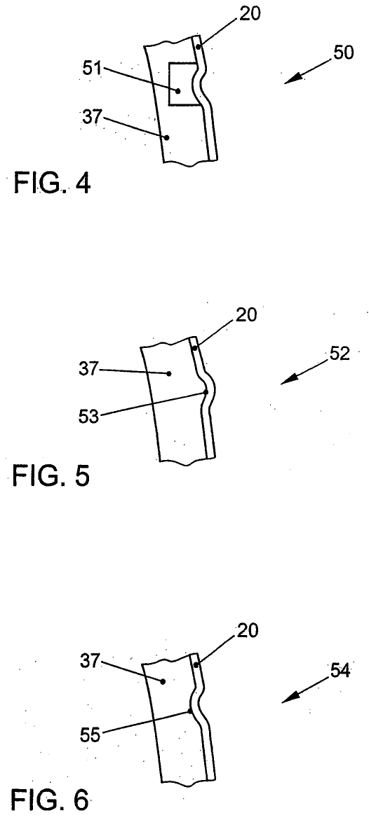

FIG. 4, FIG. 5, and FIG. 6 show operating elements 50, 52, and 54 for alternatively embodying operating elements 2, 3, 4, 5, the representation in FIG. 4, FIG. 5, and FIG. 6 approximately corresponding to the detail marked in FIG. 2 by dashed circle 35. Operating element 50 includes a pressure-measuring element 51, which is embedded in support 37 and covered by woven cover 20 and converts a pressure applied to woven cover 20 over pressure-measuring element 51 into a voltage. Pressure-measuring element 51 corresponds to pressure-measuring element 33, but it has a concave operating surface while pressure-measuring element 33 has a convex operating surface.

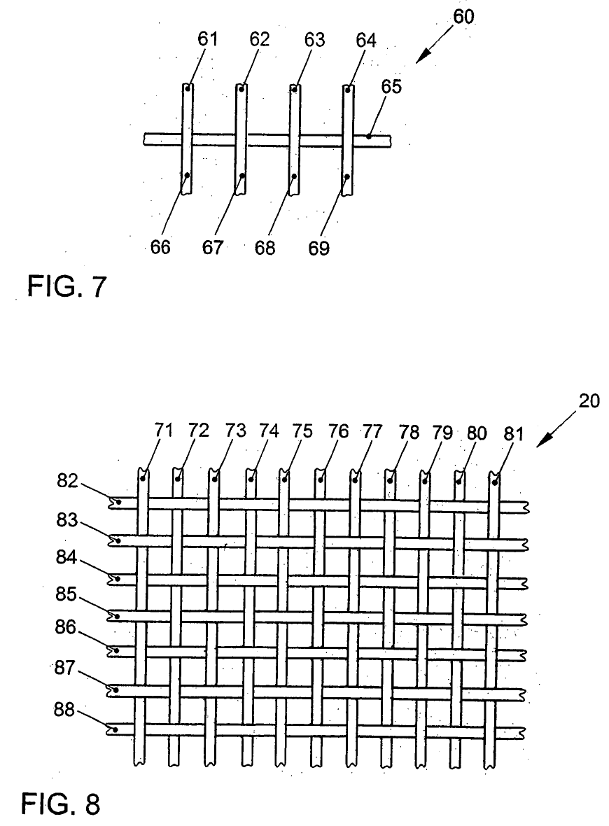

Operating elements 52 and 54 include a convexly formed region 53 of support 37 and a concavely formed region 55 of support 37, respectively. An operating element 60, which is represented in FIG. 7 and includes pressure-measuring strips 61, 62, 63, 64 crossing a pressure-measuring strip 65, may be situated between convexly formed region 53 of support 37 or concavely formed region 55 of support 37 and woven cover 20. In this context, a point of intersection denoted by reference numeral 66 may correspond to operating element 2, a point of intersection denoted by reference numeral 67 may correspond to operating element 3, a point of intersection denoted by reference 68 may correspond to operating element 4, and a point of intersection denoted by reference numeral 69 may correspond to operating element 5.

As an alternative, pressure-measuring filaments 80, 82 corresponding to pressure-measuring strips 61, 62, 63, 64, and 65 may also be woven into woven cover 20, as indicated in FIG. 8. In this context, FIG. 8 shows a schematic representation of an exemplary embodiment of woven cover 20. Woven cover 20 has an electrical heating filament 72, at least one temperature-measuring filament 73, filaments 75, 87 having piezoelectric material, pressure-measuring filaments 80, 82, and/or electroluminescent light filaments 78, 84, which are interwoven with filaments 71, 74, 76, 77, 79, 81, 83, 85, 86, 88 made of, for example, a textile material.

Electrical heating filament 72 may be, e.g., an insulated metallic or carbon filament. It may also be provided that some of filaments 71, 74, 76, 77, 79, 81, 83, 85, 86, 88 be, e.g., uninsulated metallic filaments or carbon filaments.

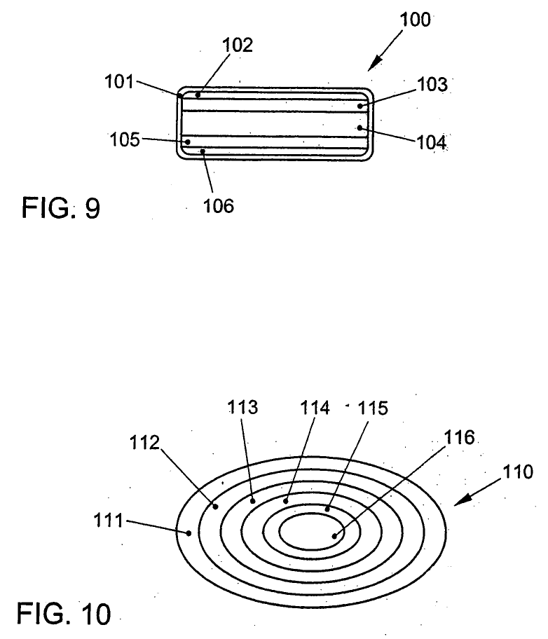

FIG. 9 and FIG. 10 show a cross-section of an exemplary embodiment of electroluminescent light filaments 100, 110, respectively, for use as electroluminescent light filament 78 and/or 84. Electroluminescent light filaments 100 and 110 have, under transparent or semitransparent protective layers 101, 111, transparent electrodes 102, 112, transparent insulating layers 103, 113, light-emitting layers (pigment layers) 104, 114, further insulating layers 105, 115, and backing electrodes 106, 116, respectively.

The light-emitting layer (pigment layer) 104 or 114 may be made of a material, in which zinc sulfide (ZnS) is used as the base material, and to which a small amount of a light-emitting core (Mn) is added. Using an energy source, light is emitted with the aid of light-emitting layers (pigment layers) 104, 114 by applying an alternating electric field across transparent electrodes 102, 112 and backing electrodes 106, 116, respectively, which are connected to electrical contacts.

In order to attain a light-emission luminance of 70 cd/m2 or more with the aid of this electroluminescent layer, the Mn concentration is, for example, approximately 0.4-0.6 wt. % (with respect to zinc sulfide). Such an electroluminescent layer may be produced, for example, by a vacuum-deposition method, by atomic layer crystal growth (ALE), by chemical vapor deposition, or by sputtering. Further details regarding the exemplary manufacturing of such an electroluminescent layer may be obtained, e.g., from German Published Patent Application No. 43 32 209.

Light-emitting layer 104 or 114 may additionally have ZnSe and/or ZnS/CdS or may be substantially made of ZnSe and/or ZnS/CdS. If pigment layer 104 or 114 is mainly made of ZnS, ZnSe, and/or ZnS/CdS, this does not preclude small amounts of other elements (in the percent range) from being provided, such as 0.4%-0.6 wt. % Mn, i.e., does not preclude pigment layer 104 or 114 from being metallically doped.

Further possible embodiments of light-emitting layer 104 or 114 are described, e.g., in European Published Patent Application No. 0 699 730.

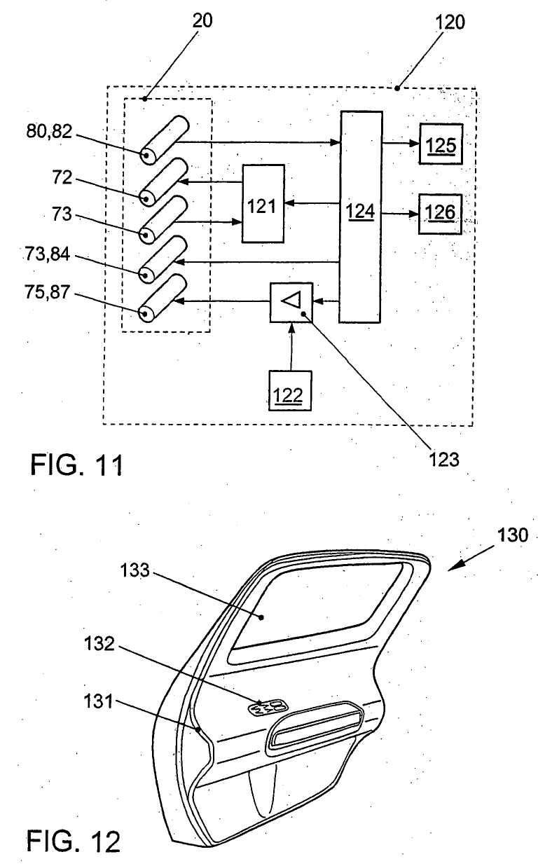

FIG. 11 shows a schematic representation of an exemplary embodiment of a vehicle 120 having woven cover 20 for, e.g., placement on surfaces of the body shell of vehicle 120 visible in the passenger compartment of vehicle 120, such as an instrument panel 1 shown in FIG. 1 or an interior trim panel 131 of a door 130 shown in FIG. 12. Vehicle 120 includes a controlling device 121, with the aid of which heating filament 72 may be powered by electrical energy. Using a signal supplied by temperature-measuring filament 73, controlling device 121 controls electrical heating filament 72 such that the operation of electrical heating filament 72 causes it to warm up to a temperature between 30° C. and 35° C. As an alternative, one may also refrain from controlling the temperature, in which case controlling device 121 is replaced with a power-supply device. In this case, the power-supply device and electrical heating filament 72 are matched to each other, i.e., in particular, an electrical resistance of electrical heating filament 72 is selected, such that the operation of electrical heating filament 72 causes it to warm up to a temperature less than 40° C., e.g., to a temperature between 30° C. and 35° C. In order to switch on and switch off electrical heating filament 72 or its controlling device 121 or its power-supply device, e.g., an appropriate operating element is provided, which is implemented, inter alia, via pressure-measuring filament 80, and whose operation is detected via an evaluation circuit 124, which in turn controls controlling device 121 or the power-supply device.

To switch on and switch off light filaments 78, 84, e.g., an appropriate operating element is provided, which is implemented, inter alia, via pressure-measuring filament 82, and whose operation is detected via evaluation circuit 124 as well.

Wove cover 20 may further include filaments 75, 87, which have piezoelectric material and function as loudspeakers. Details regarding a corresponding acoustic effect are described, for example, on the Internet page www.panphonics.fi/technology/audio_app_theory.html. Filaments 75, 87 having piezoelectric material are optionally connected to an infotainment module 122 via an adjustable amplifier 123. An infotainment module may be arranged as (, inter alia,) a navigation system, an information system, a telephone, a music system, and/or a voice system. In this manner, tones, music, and/or speech may be emitted in the passenger compartment of vehicle 120 with the aid of filaments 75, 87 having piezoelectric material. To increase or decrease the amplification of adjustable amplifier 123, e.g., an appropriate operating element is provided, which is implemented with the aid of further pressure-measuring filaments, and whose operation is detected via evaluation circuit 124 as well.

Reference numerals 125 and 126 denote further functions, which are controllable, for example, via further operating elements, which are implemented with the aid of further pressure-measuring filaments, and whose operation is detected via evaluation circuit 124. An example of such a function is a window lifter for lowering and raising a pane 133 of a motor-vehicle door 130 shown in FIG. 12. In this context, operating elements 132 for operating the window lifter are woven as pressure-measuring filaments in a woven cover of interior trim panel 131 of door 130, corresponding to woven cover 20.

The elements and layers in the figures are drawn with simplicity and clarity in mind, and not necessarily to exact scale. For example, the orders of magnitude of certain elements or layers are depicted with considerable exaggeration as compared to other elements or layers, in order to improve understanding of the exemplary embodiments described herein.

### LIST OF REFERENCE NUMERALS

1 instrument panel
2, 3, 4, 5, 50,
52, 54, 60, 132 operating element
6 instrument cluster
7 part of a center console
10, 21 foam member
11, 12 side
14 arrow
20 woven cover
23, 24, 25, 26, 31 air duct
27, 28, 29, 30, 32 air outlet
33, 51 pressure-measuring element
34, 35 dashed circle
37 support
40, 41, 42, 43,
53, 55 region
44 surface of a woven cover
45 warp thread
46 weft thread
47 crossing point
61, 62, 63, 64, 65 pressure-measuring strip
66, 67, 68, 69 point of intersection
71, 74, 76, 77,
79, 81, 83, 85,
86, 88 filament
72 heating filament
73 temperature-measuring filament
75, 87 filament having piezoelectric material
78, 84, 100, 110 light filament
80, 82 pressure-measuring filament
101, 111 protective layer
102, 112 transparent electrode
103, 105
113, 115 insulating layer
104, 114 pigment layer/light-emitting layer
106, 116 backing electrode
120 vehicle
121 controlling device
122 infotainment module
123 amplifier
124 evaluation circuit
125, 126 further function
130 door
131 interior trim panel
133 pane

1-16. (canceled)

17. A device, comprising:
a support;
a woven cover positioned over the support, the woven cover including warp threads, weft threads and crossing points of the warp threads and the weft threads, a density of the crossing points substantially independent of a surface geometry of the support;
wherein the device is arranged as one of (a) an instrument panel and (b) an interior trim panel for one of (a) a motor vehicle and (b) a vehicle.

18. The device according to claim 17, wherein the support includes a region having a flat surface and a region having a convex surface, a part of the woven cover arranged on the flat surface and a part of the woven cover arranged on the convex surface, density of the crossing points of the woven cover above the region of the support having a flat surface substantially equal to the density of the crossing points of the woven cover above the region of the support having the convex surface.

19. The device according to claim 17, wherein the support includes has a region having a flat surface and a region having a concave surface, a part of the woven cover arranged on the flat surface and a part of the woven cover arranged on the concave surface, the density of the crossing points of the woven cover above the region of the support having the flat surface substantially equal to the density of the crossing points of the woven cover above the region of the support having the concave surface.

20. The device according to claim 17, wherein a surface of the woven cover facing away from the support includes a nanocoating.

21. The device according to claim 17, wherein the support includes at least one air duct.

22. The device according to claim 21, wherein the air duct includes at least one air outlet covered by the woven cover.

23. The device according to claim 17, wherein at least one of (a) at least one warp thread and (b) at least one weft thread includes a metallic filament.

24. The device according to claim 17, wherein at least one of (a) at least one warp thread and (b) at least one weft thread includes a carbon filament.

25. The device according to claim 17, wherein at least one of (a) at least one warp thread and (b) at least one weft thread includes a pressure-measurement filament.

26. The device according to claim 17, wherein at least one of (a) at least one warp thread and (b) at least one weft thread includes a heating filament.

27. The device according to claim 17, wherein at least one of (a) at least one warp thread and (b) at least one weft thread includes a temperature-measurement filament.

28. The device according to claim 17, wherein at least one of (a) at least one warp thread and (b) at least one weft thread includes an electroluminescent light filament.

29. The device according to claim 17, wherein at least one of (a) at least one warp thread and (b) at least one weft thread includes a piezoelectric filament.

30. A vehicle, comprising:
at least one of (a) an instrument panel and (b) an interior trim panel including:
a support;
a woven cover positioned over the support, the woven cover including warp threads, weft threads and crossing points of the warp threads and the weft threads, a density of the crossing points substantially independent of a surface geometry of the support.

31. The vehicle according to claim 30, wherein the vehicle is arranged as a motor vehicle.

32. The vehicle according to claim 30, further comprising a windshield, the woven cover including a region in which a degree of light absorption of the woven cover increases with decreasing distance to the windshield.

33. A method for manufacturing at least one of (a) an instrument panel and (b) an interior trim panel, comprising:
forming a support having a geometry of the at least one of (a) the instrument panel and (b) the interior trim panel;
weaving a cover having warp threads, weft threads and crossing points, a density of the crossing points of the warp threads and the weft threads being a function of a surface geometry of the support; and
covering the support by the cover.

34. A method for manufacturing at least one of (a) an instrument panel and (b) an interior trim panel, comprising:
covering a support by a cover, the support having a geometry of the at least one of (a) the instrument panel and (b) the interior trim panel, the cover including warp threads, weft threads and crossing points, a density of the crossing points of the warp threads and the weft threads being a function of a surface geometry of the support.
